(19) United States
(12) Patent Application Publication
(10) Pub. No.: US 2004/0021575 A1
(43) Pub. Date: Feb. 5, 2004

(54) Methods and apparatus for melting snow and ice on a vehicle

(76) Inventor: John Jeffrey Oskorep, Chicago, IL (US)

Correspondence Address: JOHN J. OSKOREP, ESQ., ONE MAGNIFICENT MILE CENTER, 980 N. MICHIGAN AVE., SUITE 1400, CHICAGO, IL, 60611, US

(21) Appl. No.: 10/209,760

(22) Filed: Aug. 1, 2002

(51) Int. Cl. G01W 1/00; G08B 21/00

(52) U.S. Cl. 340/601; 219/205

(57) ABSTRACT

Methods and apparatus for melting snow and/or ice on a vehicle, such as an automobile, are disclosed. The apparatus includes a snow sensor mounted on the outside of the vehicle and a controller positioned underneath the vehicle's hood. When snowfall is detected, the controller causes an engine of the vehicle to be started one or more times along with its heater and defroster. The heat from the engine and the inside of the vehicle are transferred to the vehicle's body and windows to melt the snow/ice over the vehicle. Advantageously, snow melting is performed automatically and requires no effort or involvement from the driver of the vehicle. Preferably, the engine is started a number of times for brief time periods to keep fuel consumption low. Several advanced features are provided as well, and as some examples, the controller may be incorporated as part of an engine control unit or car alarm system of the vehicle; the controller may be configured to inhibit starting of the engine if a low fuel condition or driver in-use condition exists; and the controller may be configured to keep the snow sensing technology inactivated until a temperature reading from a temperature sensor is below a predetermined threshold and/or until physical contact from snow is detected.

### BACKGROUND OF THE INVENTION

1. Field of the Invention

The present invention relates generally to methods and apparatus for removing snow/ice accumulation on a vehicle, such as an automobile, and more particularly relates to melting snow/ice on the vehicle by detecting the presence of snow/ice and starting an engine of the vehicle one or more times along with its internal heater and/or defroster.

2. Description of the Related Art

Snow and ice removing devices for vehicles, such as automobiles, are mostly primitive in nature. The most common devices are snow and ice scrapers and brushes which are used to manually remove snow/ice after it accumulates on a vehicle. Oftentimes, the driver of the vehicle removes the snow/ice with the scraper right before driving the vehicle. This is inconvenient because the driver often does not have the extra time it takes to fully remove the snow/ice before vehicle use. It is dangerous for drivers to use vehicles with snow/ice accumulation, as the snow/ice often covers the front and rear windshields and side windows of the vehicle to thereby obstruct the view of the driver while driving.

Other devices for keeping snow off automobiles include tarps or mats which are placed over a portion of the automobiles, such as the windshield. These devices are inconvenient because they need to be positioned over the vehicle each time the driver leaves and removed each time the driver needs to use it again. Snow sensors are known and used for detecting the presence of snow, but are known only to be used to melt snow/ice that accumulates over sidewalks, roadways, or rooftops in connection with separate heating systems.

### SUMMARY OF THE INVENTION

Methods and apparatus for melting snow and/or ice over a vehicle, such as an automobile, are disclosed. In one illustrative embodiment of the invention, the vehicular snow melting apparatus includes a snow sensor mounted on the outside of the vehicle coupled to a controller positioned underneath the vehicle's hood. When snowfall is detected, the controller causes an engine of the vehicle to be started one or more times along with its heater and defroster. The heat from the engine and from the inside of the vehicle are transferred to the vehicle's body and windows to melt the snow/ice over the vehicle. Advantageously, snow melting is performed automatically and requires no effort or involvement from the driver of the vehicle.

Preferably, the engine is started a plurality of times for relatively brief time periods to keep fuel consumption of the vehicle low. Thus, even after the engine and heater/defroster are turned off, the vehicle remains warm enough to continue to melt snow/ice. Preferably, the durations over which the engine is kept on and the number of times the engine is started are determined through empirical analysis both to ensure that snow/ice is melted and to reduce or minimize the fuel consumption of the vehicle.

Several advanced features are also described. As some examples, the controller may be incorporated as part of an engine control unit (ECU) or car alarm system of the vehicle. The controller may also be configured to inhibit starting of the engine if a low fuel condition, a low battery condition, and/or an in-use condition is detected. To help minimize vehicular battery consumption while the engine is off, the controller may be configured to keep the snow sensing circuitry inactive until a temperature reading from a temperature sensor is detected to be below a predetermined threshold, until physical snow contact is detected by a physical object detector, and/or when a battery voltage is above a predetermined threshold.

### BRIEF DESCRIPTION OF THE DRAWINGS

FIG. 1 is an illustration of one type of vehicle, namely an automobile, which has an inventive apparatus for removing snow and ice accumulation including a sensor which detects a presence of snow and a controller which causes an engine of the vehicle to be started one or more times along with its heater and defroster;

FIG. 2 is a schematic block diagram of the apparatus of FIG. 1 in a first embodiment;

FIG. 3 is a schematic block diagram of the apparatus of FIG. 1 in a second embodiment;

FIG. 4 is a schematic block diagram of the apparatus of FIG. 1 in a third embodiment;

FIG. 5 is a flowchart which describes an inventive method of removing snow and/or ice on a vehicle;

FIG. 6 is the first in a series of illustrations of FIGS. 6-9 which describe one particular method of operating the snow removing apparatus, showing more particularly a state transition diagram of the apparatus which includes a low power state, a snow monitor state, and an engine/heater on state;

FIG. 7 is the second in the series of illustrations of FIGS. 6-9 which describe the one particular method of operating the snow removing apparatus, showing more particularly a method of operating in the low power state;

FIG. 8 is the third in the series of illustrations of FIGS. 6-9 which describe the one particular method of operating the snow removing apparatus, showing more particularly a method of operating in the snow monitor state;

FIG. 9 is the fourth in the series of illustrations of FIGS. 6-9 which describe the one particular method of operating the snow removing apparatus, showing more particularly a method of operating in the engine/heater on state;

FIG. 10 is a block diagram which shows an engine control unit which incorporates the snow removing processes of the present invention;

FIG. 11 is a block diagram which shows a car alarm unit which incorporates the snow removing processes of the present invention; and

FIG. 12 are three graphs which show a theoretical example run of the present invention, the first graph showing snow accumulation on the ground, the second graph showing operating states of the snow removing apparatus in response to the snow accumulation, and the third graph showing snow accumulation on the vehicle with the snow removing apparatus in operation.

### DETAILED DESCRIPTION OF THE PREFERRED EMBODIMENTS

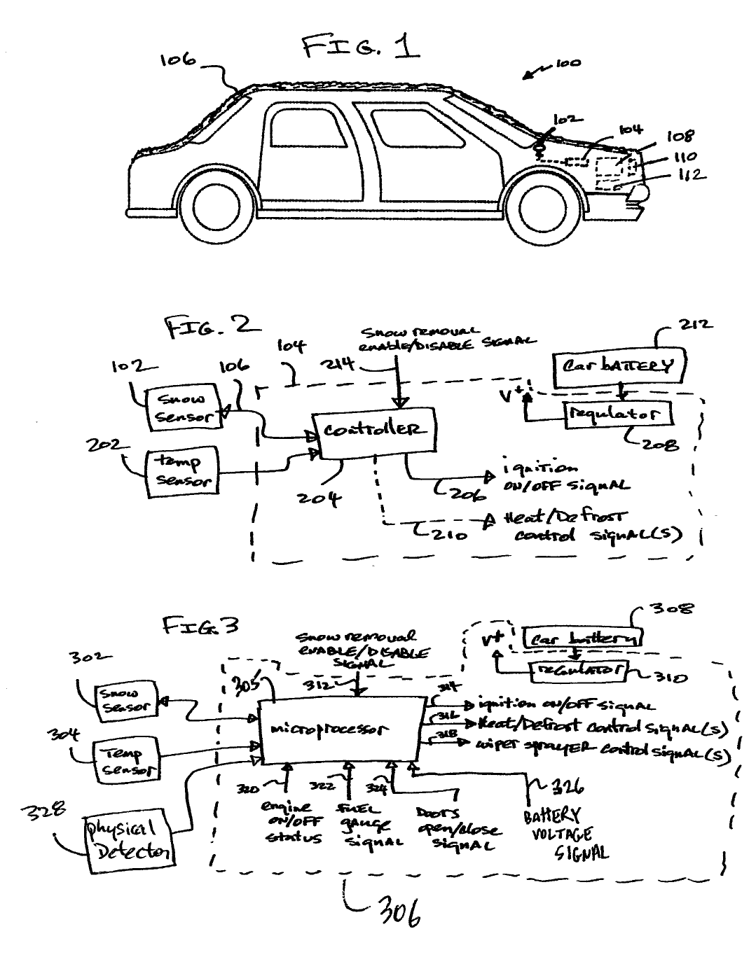

FIG. 1 is an illustration of one type of a vehicle 100, namely a conventional automobile, which has an inventive apparatus for removing snow and ice 106 which accumulates over it Vehicle 100 includes a conventional vehicular engine 108 for moving the vehicle, a conventional vehicular battery 110, and a conventional internal heater and/or defroster system 112 for heating the inside of the vehicle. Engine 108 may be a conventional gasoline-powered engine or, alternatively, a battery-powered engine of an electric vehicle. Being a ground or land moving vehicle 100 with four wheels which are propelled by engine 108, vehicle 100 may be referred to as an engine-propelled vehicle.

The vehicular snow melting apparatus includes a sensor 102 and a controller 104. Sensor 102 is used for detecting a presence of snow and/or ice accumulation over vehicle 100. Sensor 102 is positioned or mounted on vehicle 100 at a location suitable to detect snowfall or ice buildup over the vehicle. In the present embodiment, sensor 102 is positioned on top of vehicle 100 at or near a front of the radio antenna of the vehicle. However, any suitable position would be appropriate. Sensor 102 may be any sensor which is suitable to detect the presence of snow and/or ice, and may be a snow sensor. For example, sensor 102 may be the snow sensor model number “CIT-1” manufactured by and currently available from Environmental Technology, Inc. (or ETI) of South Bend, Ind., U.S.A. As another example, sensor 102 may be the snow sensor described in U.S. Pat. No. 5,345,223 entitled “Snow Sensor”.

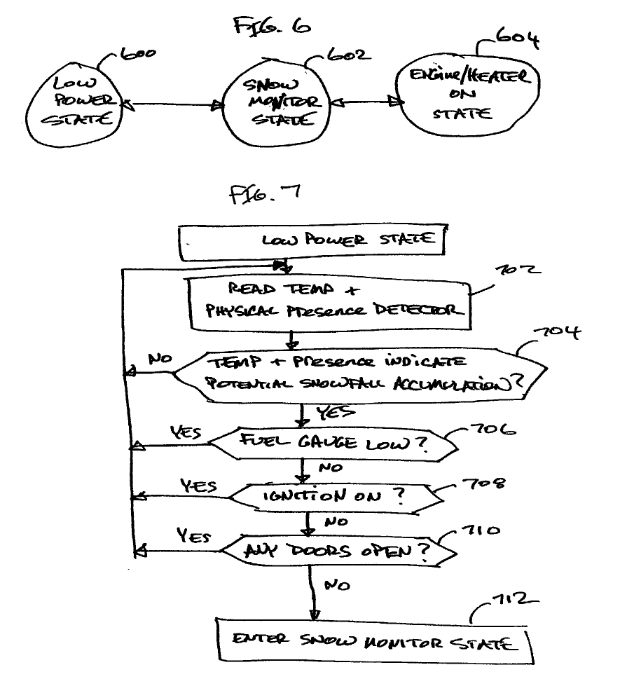

Sensor 102 is coupled to controller 104 through one or more electrical conductors or wires. Controller 104 may be included in a special module or housing that is mounted underneath the hood of vehicle 100. Any suitable placement for controller 104 is appropriate, however, with a preference towards concealment. Controller 104 may be or include any suitable controller, circuitry, processor, microprocessor, microcontroller, or the like, for controlling the engine and/or heater system based on signals from sensor 102. Preferably, controller 104 is a microprocessor which is programmed with software instructions for executing the methods described herein. For example, the software instructions may perform the method described later in relation to FIG. 5 or FIGS. 6-9.

In general, controller 104 is configured to cause engine 108 of vehicle 100 to be started one or more times in response to a detection of snow/ice over the vehicle. The heat from engine 108 transfers to the body of vehicle 100 to melt the snow. Controller 102 receives signals from sensor 102 which indicate that snow/ice is present and, in response, engages the appropriate signal lines for starting engine 108.

Preferably, the methodology is more advanced to conserve fuel. Instead of being turned on once for a relatively long period of time, the controller causes the engine to be turned on and off a plurality of times for relatively short periods of time in response to a snowfall accumulation. This methodology takes advantage of the fact that the vehicle body remains warm even when the engine is off after it has been running for a sufficient time period beforehand. If an average snowfall occurs over an hour time period, for example, instead of turning on the engine once for 30 minutes, the method may cause the engine to be turned on twice for 7 minutes at half hour intervals. Preferably, the durations over which the engine is kept on and the number of times the engine is started are determined through empirical analysis both to ensure that snow/ice is melted and to reduce or minimize the fuel consumption of the vehicle.

When controller 104 causes engine 108 to start, engine 108 is preferably started along with heater/defroster system 110 of vehicle 100. This may be done simply by controller 104 engaging the appropriate input signal lines to heater/defroster system 100 as or after engine 108 is started. In this case, the heat from both engine 108 and heater/defroster system 112 transfers to the body and windows of vehicle 100 to melt the outside snow. Alternatively, heater/defroster system 112 may be engaged by instructing the driver of vehicle 100 to place or keep the switch for heater/defroster system 100 in an active or “on” position when departing from vehicle 100. In this case, when engine 108 is started by controller 104, heater/defroster system 112 will automatically be engaged.

As another alternative, controller 104 may not cause engine 108 to be started in response to the snow/ice presence, but rather only cause heater/defroster system 112 to be started in response to detecting the presence of snow/ice. This latter alternative may be more suitable for electric vehicles which are electrically powered by batteries and not gasoline fuel, but is possible for gasoline powered or hybrid engines as well.

Advantageously, the heat from the engine and the inside of the vehicle are transferred to the vehicle's body and windows to melt the snow/ice over the vehicle. Snow melting is performed automatically and requires no effort or involvement from the driver of the vehicle. Once enabled, the apparatus will perform appropriately whether the vehicle is left outdoors or indoors (e.g. a garage) where snowfall detection would not occur (and the engine would not be started).

Controller 104 is interfaced with the appropriate signal lines in vehicle 100 for turning on and off engine 108, and/or heater/defroster system 112, and other lines to provide more advanced features. More particularly, controller 104 may be interfaced with an engine control unit (ECU) of vehicle 100. Preferably, controller 104 is incorporated as part of the ECU module of vehicle 100 and, most preferably, is the same controller or processor utilized in the ECU. See FIG. 10, which illustrates an ECU 1002 which has an automobile engine control process 1004 as well as a snow removal process 1006. Automobile engine control process 1004 includes the conventional process used to run the vehicle's engine, whereas snow removal process 1006 employs the snow melting methodologies described herein.

The ECU, also known as the “computer” of a vehicle, uses a control scheme that continuously monitors inputs and outputs of the automobile system and manages the emissions and fuel economy of the engine as well as a host of other parameters. The ECU gathers data from dozens of different sensors in the vehicle and knows everything from the coolant temperature to the amount of oxygen in the exhaust With this data, the ECU performs millions of calculations each second in order to decide on, for example, the best spark timing and how long the fuel injector is open.

Referring back to FIG. 1, if the snow melting method is incorporated as part of the ECU, then sensor 102 and controller 104 are preferably physically separable elements. This way, the snow melting apparatus may be provided as a separate add-on feature for vehicle 100. In this case, the snow melting methodology is programmed into every controller/ECU, but sensor 102 is provided as a separate item which may or may not be installed later (e.g. upon sale of vehicle 100). Sensor 102 may have the electrical conductors secured to it and a connector on one end of these conductors. This connector is configured to mate with a corresponding connector which is coupled to the controller/ECU. Thus, when the feature is desired, the connector of sensor 102 is mated with the controller's connector. Preferably, the controller/ECU automatically detects this connection and, in response, automatically enables the snow melting methodology.

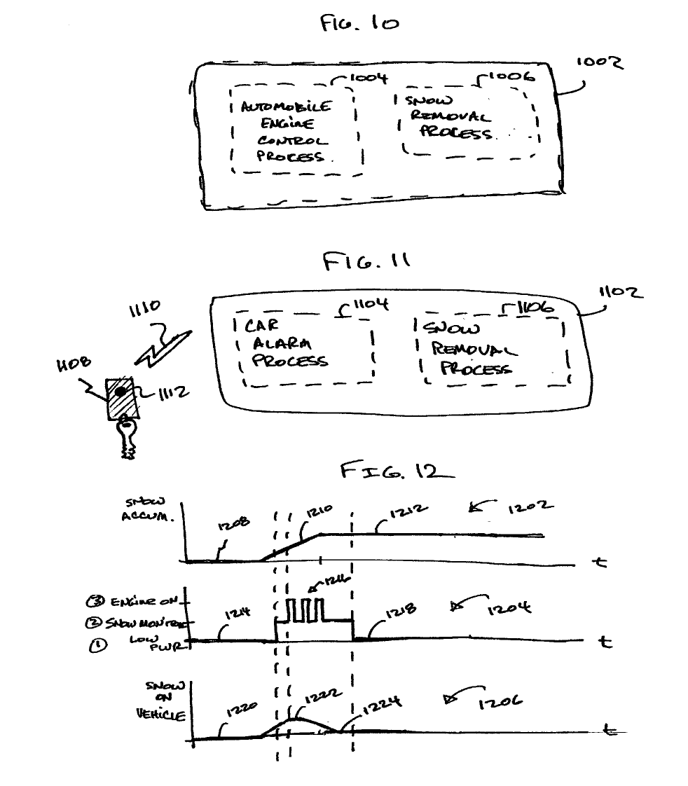

In an alternate embodiment, controller 104 is included in a car alarm system which is installed within vehicle 100. In this case, controller 104 is preferably the same controller that is used for the car alarm system of vehicle 100. See FIG. 11, which shows a car alarm system unit 1102 which includes a car alarm process 1104 as well as a snow removal process 1106. Car alarm process 1104 includes the conventional process used to provide security and alerting for the vehicle, whereas snow removal process 1106 employs the snow melting methodologies described herein. As another alternative, controller 104 is included in a combined ECU/car alarm system of vehicle 100, and may be the same controller that is utilized in the combined ECU/car alarm unit of vehicle 100.

FIG. 2 is a schematic block diagram of the vehicular snow melting apparatus of FIG. 1 in a first embodiment. The vehicular snow melting apparatus of FIG. 2 includes a snow sensor 102 coupled to a module 104 through a wired connection 106. Module 104, which may be an ECU, a car alarm system module, or a separate stand-alone module, includes a controller 204 which is coupled to snow sensor 102. In response to the detection of snow/ice, controller 204 utilizes an output control line 206 to turn on the engine of the vehicle. Alternatively, or in combination with activating output control line 206, controller 204 may utilize an output control line 210 to turn on the heater/defroster system of the vehicle. Controller 204 and other circuitry in module 104, including snow sensor 102, are coupled to and electrically powered by a vehicular battery 212 through a regulator 208, in a conventional fashion as any electronic automotive circuit would be powered.

An enable line 214 is coupled to controller 204 for enabling/disabling the functionality of the vehicular snow melting apparatus. Enable line 214 may be controlled by a driver-controllable switch, and/or programming of the apparatus by the manufacturer (e.g. with an electrically erasable/programmable read-only memory or EEPROM). If a driver-controllable switch is provided, it may be provided as a button or toggle switch in a separate small housing which is positioned in the vehicle underneath the dashboard. On the other hand, the driver-controllable switch may be a driver-controllable wireless switch, for example, a conventional wireless device commonly utilized to lock/unlock doors and enable/disable a car alarm of the vehicle. See again FIG. 11, which shows car alarm system unit 1102 controllable by a wireless switch 1108 which can enable/disable the car alarm, lock and unlock the vehicle doors, and also enable/disable the snow melting apparatus. These functions may be employed by pressing a button on wireless switch 1108, such as a button 1112. Thus, wireless switch 1108 is otherwise conventional in nature but includes part of the switching mechanism to turn on and off the snow melting apparatus. Wireless switch 1108 may also provide functionality to turn on and off the engine by an actuation of another button, as is conventional.

Referring back to FIG. 2, a temperature sensor 202 may also be included as part of the vehicle snow melting apparatus. Temperature sensor 202 is coupled to controller 204 through a wired connection. Temperature sensor 202 may be mounted along with sensor 102, or included as part of sensor 102, or be the existing temperature sensor 202 already included in the vehicle. Temperature sensor 202 is mounted such that it can detect an outside temperature or, alternatively, a temperature of the vehicle itself (e.g. the temperature of the hood or windshield of the vehicle). On the other hand, two temperature sensors may be utilized, one for detecting the outside ambient temperature and one for detecting the temperature of the vehicle itself. A plurality of temperature sensors may be utilized and mounted at various different locations on the vehicle. In this case, controller 204 may read different temperatures around the vehicle and calculate a working temperature based on all of the readings.

Controller 204 may utilize the temperature readings from temperature sensor 202 in a number of different ways. In one embodiment, controller 204 regularly places snow sensor 202 and associated circuitry in a completely inactive state or low power state until temperature sensor 202 provides a temperature reading that is below freezing (or below any other suitable predetermined temperature). More particularly, controller 204 activates sensor 202 and associated circuitry only during temperature ranges within which snow can fall or exist (or is most likely to fall or exist). This way, little or no power from vehicular battery 212 is consumed until it is more certain that snowfall can occur. In a more particular embodiment, when controller 204 places sensor 202 and associated circuitry in an active state, the active state involves powering on sensor 202 and associated circuitry for a first short time period and then powering it down for a second time period before powering it back on again. For example, when controller 204 reads a temperature that is suitable for snowfall, it activates sensor 202 every 15 minutes for 1 minute time intervals. Of course, any suitable number of time periods may be utilized.

In another embodiment, which may be employed together with the above embodiments, controller 204 utilizes ambient temperature readings from temperature sensor 202 to decide how long the engine should be kept running or how many times to start the engine. To illustrate, controller 204 keeps the engine on longer and/or turns on the engine more often when the temperature is relatively very cold. In another variation, controller 204 utilizes vehicle temperature readings from a temperature sensor to decide when to shut down the engine and when to turn it back on. For example, there may be a suitable predetermined temperature of the vehicle below which controller 204 will turn on the vehicle, and a suitable predetermined temperature above which controller 204 will turn off the vehicle.

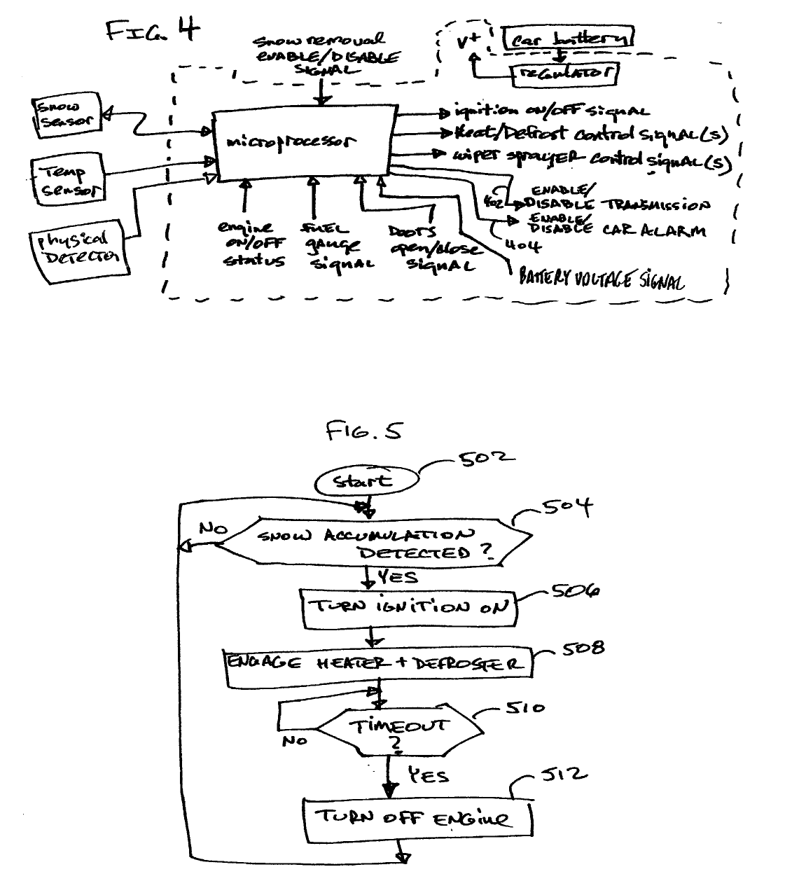

FIG. 3 is a schematic block diagram of the vehicular snow melting apparatus of FIG. 1 in a second embodiment The apparatus of FIG. 3 is the same as that described in relation to FIG. 2 except that it is more advanced. The apparatus includes a snow sensor 302 and a temperature sensor 304 which are coupled to a module 306. All circuitry is coupled to and electrically powered by vehicular battery 308 which is regulated by a regulator 310. Sensors 302 and 304 are coupled to a controller 305, which in this embodiment is a microprocessor. An enable signal line 312 controls the enabling and disabling of the snow/ice melting apparatus, as described in relation to FIG. 2. Similar to the apparatus of FIG. 2, the vehicle snow melting apparatus of FIG. 3 has lines 314 and 316 from controller 305 which cause the engine and the heater defroster to be started. In addition, a line 318 to cause one or more windshield wipers to be engaged when appropriate to clear snow from front and/or rear windshields of the vehicle. This may be required only a few times for a short period of time when the engine is running.

Controller 305 also monitors various signal lines from the vehicle, including an engine on/off status line 320, a fuel gauge signal line 322, a vehicle in-use signal line 324 (e.g. vehicle doors open/closed signals), and a battery voltage signal line 326. Controller 305 may disable or shut down the snow melting apparatus (e.g. disable its ability to turn the engine on in response to snow) when engine on/off status line 320 indicates that the engine is on and re-enable it when it indicates that the engine is off. Similarly, controller 305 may disable or shut down the snow melting apparatus when fuel gauge signal line 322 indicates that the fuel level is too low (i.e. it is below a predetermined threshold) and re-enable it when it indicates that the fuel level is adequate. Controller 305 may similarly disable or shut down the apparatus when the battery voltage line 326 indicates that the battery is too low, and re-enable when it is adequate. Finally, if the vehicle is in-use by the driver, signaled by vehicle in-use line 324, then the apparatus will be shut down so as not to disturb the driver's use. Driver in-use conditions include open vehicle doors or trunk, for example.

The apparatus of FIG. 3 may also include a physical object detector 328 coupled to controller 305. Object detector 328 is mounted on top of the vehicle as is snow sensor 302. Physical object detector 328 provides signals to controller 305 which indicate whether a physical presence or obstruction from any physical material (e.g. snow) exists over the vehicle. Object detector 328 may be any conventional detector suitable to function in the manner intended. For example, object detector 328 may be the detector utilized as U.S. Pat. No. 5,844,471 entitled “Heated Vehicle Exterior Object Sensor”. Controller 305 and associated circuitry may be kept in a low power state and monitor signals from object detector 328 until a physical material (e.g. snow) is detected, whereupon controller 305 wakes up and enters a snow monitor state. Both object detector 328 and temperature sensor 304 may be together utilized to keep power consumption at a minimum.

FIG. 4 is the same as that shown and described in relation to FIG. 3, but includes advanced signaling lines such as an enable/disable transmission line 402 and/or an enable/disable car alarm line 404. When the snow melting apparatus is going to start the engine of the vehicle, it disables the vehicle's transmission through enable/disable transmission line 402 so that the vehicle cannot be driven (i.e. for security). Any other suitable way to disable the driving of the vehicle may be employed as well. Also, when the snow melting apparatus is going to start the engine of the vehicle, the controller may engage the appropriate lines to lock (or confirm locking of) the electronic door locks on the vehicle (i.e. for security). Also, when the apparatus is going to start the engine of the car, the controller enables (or confirms enabling of) those features of the car alarm system which causes the alarm to activated when the vehicle doors are open. Alternatively, or in combination with the above, when the apparatus is going to start the engine of the car, the controller disables those features of the car alarm system which would otherwise activate the alarm from the engine being turned on through enable/disable car alarm line 404. These added features are more suitable if the snow melting methodology is incorporated in the ECU, car alarm, or combined unit.

FIG. 5 is a flowchart which describes a general method of removing snow and/or ice on a vehicle. This method may be employed using any of the suitable circuits and components described above in relation to FIGS. 1-4. Beginning at a start block 502 of FIG. 5, a test is performed to determine whether sufficient snowfall has accumulated over the vehicle (step 504). This step is performed at least using the snow sensor and the controller. If no or insufficient snowfall has accumulated, the monitoring continues on a regular basis. If sufficient snowfall is detected, the controller causes the engine of the vehicle to be started (step 506). Next, the heater and/or defroster system of the vehicle is engaged, either by the controller itself or from being manually left on by the driver (step 508). When a sufficient time has elapsed, which is monitored and determined by the controller, the controller causes the engine of the vehicle to be turned off (step 512). Even after the engine and heater of the vehicle have been turned off, the vehicle is still warm enough to melt snow on the vehicle. The process repeats for additional accumulated snow on the vehicle.

Alternatively, instead of being turned on and off only once in response to a detected snowfall accumulation, the method is preferably more advanced to conserve fuel. In response to a snowfall accumulation, the method preferably turns on and off the engine a plurality of times for relatively short periods of time. This methodology takes advantage of the fact that the vehicle body remains warm even after the engine has been running for a sufficient time period. If an average snowfall occurs over an hour time period, for example, instead of turning on the engine once for 30 minutes, the method may cause the engine to be turned on twice for 7 minutes at half hour intervals.

FIG. 6 is the first in a series of illustrations of FIGS. 6-9 which describe one more particular method of operating the snow removing apparatus, showing more particularly a state transition diagram for the apparatus. The state transition diagram illustrates a “low power state” 600, a “snow monitor state” 602, and an “engine/heater ON state” 604 of the apparatus. In the low power state 600, the engine and the heater/defroster system is off, and the snow sensor/sensing is either off or minimal. In snow monitor state 602, the engine and the heater/defroster system is off, but the snow sensor/sensing is active. Engine turn-on may be imminent due to sufficient snowfall accumulation or the expiration of a timer (for additional vehicle heating where snow has recently been detected and the engine previously turned on). In engine/heater ON state 604, the engine and/or the heater/defroster system is turned on by the apparatus.

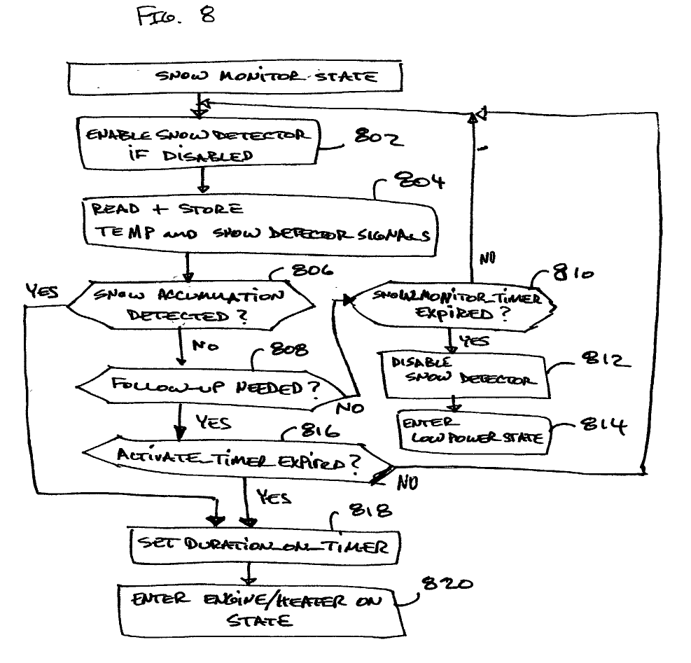

FIG. 7 is the second in the series of illustrations of FIGS. 6-9 which describe the one particular method of operating the snow removing apparatus, showing more particularly a method of operating in the “low power state” as previously described in relation to FIG. 6. This method makes use of a temperature sensor and a physical object sensor, but they are not required. The controller of the apparatus reads and/or determines the ambient temperature as well as signals from the object sensor (step 702). If the temperature reading and the object sensor both indicate that snowfall may be present (step 704), then the method continues testing for additional conditions. If the controller determines that the temperature is not conducive for snowfall, or the object sensor does not sense any obstruction from snow, the controller goes back to step 702 and continues monitoring the conditions from the sensors. Of course, only one of these sensors may be utilized in practice where the controller performs logically in connection with only the single sensor.

If the potential for snow exists as determined by the test in step 704, the controller will enter the “snow monitor state”—unless other obstructing conditions exist If the fuel gauge is low as tested in step 706 (as determined based on a predetermined low fuel indication or by comparing the current fuel level to a predetermined threshold), the entry into the snow monitor state is aborted and the method begins again at step 702. The battery voltage level may be tested in the same manner. If the fuel level (and/or battery voltage level) is adequate, then it is tested in step 708 whether the engine is on. If the engine is on, the entry into the snow monitor state is aborted and the method starts again at step 702. If the engine is off, then it is tested in step 710 whether any vehicle doors and trunk are open. If these vehicle in-user conditions exist, the entry into the snow monitor state is aborted and the method starts again at step 702. If the vehicle doors are all closed, then the controller enters the “snow monitor state” in step 712.

FIG. 8 is the third in the series of illustrations of FIGS. 6-9 which describe the one particular method of operating the snow removing apparatus, showing more particularly a method of operating in the “snow monitor state” as described in relation to FIG. 6. When entering the snow monitor state, if the snow sensor/sensing was previously disabled or shut down, it is enabled and/or turned on (step 802). Next, temperature readings and snow sensor signals are read and stored (step 804). Preferably, the controller keeps a plurality of these readings stored in memory as a sufficient “weather history” data list (e.g., history of the temperature and snow conditions for the previous hour). Based on these readings and possibly some analysis, the controller determines whether sufficient snowfall has accumulated (step 806). If so, the controller is placed in the “engine/heater ON state” (step 820) after setting a timer called DURATION_ON_TIMER (step 818) which determines how long the engine should be kept running.

If the controller determines that insufficient or no snowfall has accumulated in step 806, it checks whether follow-up from a previously determined snowfall accumulation might be needed at step 808. It may do this by testing a flag called FOLLOW_UP_FLAG. If so, the controller checks whether a timer called ACTIVATE_TIMER has expired at step 816. ACTIVATE_TIMER determines the delay time before restarting the engine when follow-up is needed. If ACTIVATE_TIMER has expired, then DURATION_TIMER is set in step 818 and the engine/heater ON state is entered at step 820. If ACTIVATE_TIMER has not expired in step 816, then the method starts again at step 802.

If follow-up is not needed as checked in step 808, then the controller checks whether a timer called SNOW_MONITOR_TIMER has expired. SNOW_MONITOR_TIMER determines the maximum time that controller remains in the snow monitor state when no snowfall events (accumulation, follow-up, etc.) have occurred. If SNOW_MONITOR_TIMER has expired, then the snow sensor is disabled or shut down in step 812 and the low power state is entered in step 814. If SNOW_MONITOR_TIMER has not expired, then the method begins again at step 802. SNOW_MONITOR_TIMER should be reset upon each reentry of the snow monitor state, and should always be greater than ACTIVATE_TIMER.

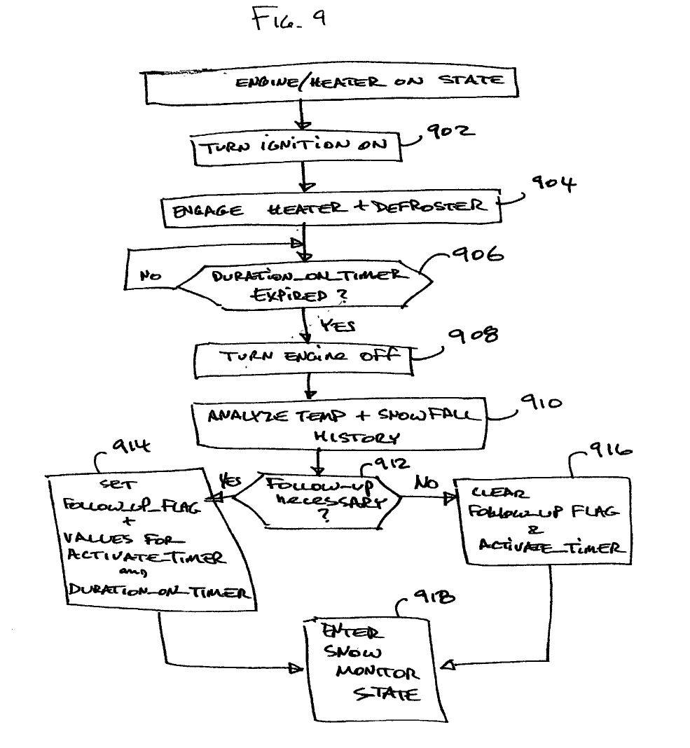

FIG. 9 is the fourth in the series of illustrations of FIGS. 69 which describe the one particular method of operating the snow removing apparatus, showing more particularly a method of operating in the “engine/heater on state” described in relation to FIG. 6. In this state, the controller begins by causing the engine of the vehicle to be turned on (step 902). Next, the controller may cause the heater/defroster system to be turned on as well (step 904). Alternatively, only the heater/defroster system is turned on. Next, the controller checks whether the DURATION_ON_TIMER has expired (step 906). When this eventually happens, the controller causes the engine (and/or the heater/defroster system) of the vehicle to be turned off (step 908).

The controller then analyzes the stored temperature and snowfall history data (step 910). Based on this data, the controller determines whether follow-up (additional engine start-ups) is necessary (step 912). If follow-up is necessary, then the FOLLOW_UP_FLAG and the values for ACTIVATE_TIMER and DURATION_ON_TIMER are set (step 914), and the snow monitor state is entered (step 918. If no follow-up is necessary as determined in step 912, then the FOLLOW_UP_FLAG and ACTIVATE_TIMER are cleared (step 916) and the snow monitor state is entered (step 918).

FIG. 12 are three graphs which show an illustrative theoretical example run of the present invention. A first top graph 1202 of FIG. 13 shows an example of snow accumulating over a period of time on a vehicle which does not use the snow melting apparatus of the present invention. As illustrated in this first graph 1202, over a time period 1208 there is no snowfall. However, as snow starts to fall it accumulates as shown by the upward slope of the line over a time period 1210. Eventually the snowfall stops but during time period 1212 (which is indefinite) the snow accumulation remains over the vehicle.

A second middle graph 1204 of FIG. 12 shows operating states (1=low power state; 2=snow monitor state; 3-engine/heater ON state) of the snow removing apparatus in response to the snow accumulation over the same period of time described in relation to the first graph 1202. The apparatus rests in the low power state during a time period 1214 where no snowfall is occurring. When snowfall occurs and sufficiently accumulates, during a time period 1216 it is shown that the apparatus enters the snow monitor state and the engine/heater ON state a number of times during the accumulation. In this example, the engine is turned on and off three times. Sometime after the snowfall ceases, and the vehicle has melted the snow, the apparatus again enters the low power state until the next snowfall.

A third bottom graph 1206 of FIG. 12 shows snow accumulation on the vehicle having the snow removing apparatus in operation over the same time period. No snow accumulation over the vehicle exists during a time period 1220, but it begins to accumulate during a time period 1222. During time period 1222 the apparatus turns on and off the engine a few times to reduce the accumulation during and after the snowfall. At a time period 1224, the snow accumulation is completely removed.

Although specific methodologies have been described herein, any suitable existing conventional components and methodologies may be employed in the vehicular snow melting apparatus, for example, the sensors and methodologies described in U.S. Pat. No. 5,345,223 entitled “Snow Sensor” and U.S. Pat. No. 6,276,202 entitled “Device and Method for Detecting Snow and Ice”, hereby incorporated by reference herein, may be suitable.

Thus, a vehicular snow melting apparatus and associated method have been described. The method of melting snow over an engine-propelled vehicle includes the acts of detecting a presence of snow over the vehicle and causing an engine of the vehicle to be started one or more times based at least in part on detecting the presence of snow. The act of causing the engine of the vehicle to be started causes snow on the vehicle to be melted. The act of causing the engine of the vehicle to be started may include causing a heater and/or defroster of the vehicle to be started. The act of causing the engine of the vehicle to be started may include causing the engine to be started a plurality of times over a time period to melt snow on the vehicle.

Other acts of the method include detecting a temperature and causing the engine of the vehicle to be started based at least in part on detecting the presence of snow when the temperature is below a predetermined threshold. The method may also include detecting a low fuel condition and inhibiting the act of causing the engine to be started based on detecting the low fuel condition. The method may also include detecting a low battery condition and inhibiting the act of causing the engine to be started based on detecting the low battery condition. The method may include detecting driver use of the vehicle and inhibiting the act of causing the engine to be started based on detecting the use of the vehicle. Also, the method may include detecting physical contact from snow and placing the snow sensor in an active state from an inactive state based at least in part on detecting the physical contact from snow. Other acts may occur when the engine is started including causing doors of the vehicle to be locked; causing a transmission of the vehicle to be disabled; causing a car alarm to be enabled; causing a car alarm for engine startup to be disabled; causing a windshield wiper of the vehicle to be engaged; and causing the engine to be turned off in response to detecting a manual turn-off switch signal.

An inventive apparatus for melting snow over an engine-propelled vehicle is able to perform the methods previously described. The apparatus includes a sensor for use in detecting a presence of snow over the vehicle; and a controller which is configured to cause an engine of the vehicle to be started one or more times based at least in part on the presence of snow being detected. The controller is configured to be coupled to an automotive battery of the vehicle for receiving electrical power. The controller is preferably incorporated in or comprises an engine control unit (ECU) or a car alarm system of the vehicle. If incorporated as part of the ECU, the snow melting methodology is easily programmed in the existing ECU microcontroller and its supporting components are held within the ECU.

It is to be understood that the above is merely a description of preferred embodiments of the invention and that various changes, alterations, and variations may be made without departing from the true spirit and scope of the invention as set for in the appended claims. None of the terms or phrases in the specification and claims has been given any special particular meaning different from the plain language meaning to those skilled in the art, and therefore the specification is not to be used to define terms in an unduly narrow sense.

What is claimed is:

1. In a vehicular snow melting apparatus, a method of melting snow over an engine-propelled vehicle comprising the acts of:
detecting a presence of snow over the vehicle; and
causing an engine of the vehicle to be started one or more times based at least in part on detecting the presence of snow.

2. The method of claim 1, wherein a sensor is used to detect the presence of snow and a controller is used to cause the engine to be started, and wherein the act of causing the engine of the vehicle to be started causes snow on the vehicle to be melted.

3. The method of claim 1, wherein the act of causing the engine of the vehicle to be started comprises causing a heater and/or defroster of the vehicle to be started, and wherein the acts of causing the engine and the heater and/or the defroster to be started causes snow on the vehicle to be melted.

4. The method of claim 1, further comprising:
causing a heater and/or defroster of the vehicle to be started; and
wherein the acts of causing the engine and the heater and/or the defroster to be started causes snow on the vehicle to be melted.

5. The method of claim 1, wherein the act of causing the engine of the vehicle to be started comprises causing the engine to be started a plurality of times over a time period to melt snow on the vehicle.

6. The method of claim 1, wherein the act of causing the engine of the vehicle to be started comprises causing the engine to be started a plurality of times over a time period along with a heater and/or defroster of the vehicle to melt snow on the vehicle.

7. The method of claim 1, further comprising:
detecting a temperature; and
causing the engine of the vehicle to be started based at least in part on detecting the presence of snow when the temperature is below a predetermined threshold.

8. The method of claim 1, further comprising:
detecting a low fuel condition; and
inhibiting the act of causing the engine to be started based on detecting the low fuel condition.

9. The method of claim 1, further comprising:
detecting driver use of the vehicle; and
inhibiting the act of causing the engine to be started based on detecting the use of the vehicle.

10. The method of claim 1, wherein a sensor is utilized to detect the presence of snow, the method further comprising:
detecting physical contact from snow; and
placing the snow sensor in an active state from an inactive state based at least in part on detecting the physical contact from snow.

11. The method of claim 1, further comprising:
causing at least one of the following acts to occur at around the time the engine is started or running due to the presence of snow being detected:
causing doors of the vehicle to be locked;
causing a transmission of the vehicle to be disabled;
causing a car alarm to be enabled;
causing a car alarm for engine startup to be disabled;
causing a windshield wiper of the vehicle to be engaged; and
causing the engine to be turned off in response to detecting a manual turnoff switch signal.

12. An apparatus for melting snow on an engine-propelled vehicle, comprising:
a sensor for use in detecting a presence of snow over the vehicle;
a controller; and
the controller being configured to cause an engine of the vehicle to be started one or more times based at least in part on the presence of snow being detected.

13. The apparatus of claim 12, further comprising:
the controller being configured to cause a heater and/or defroster of the vehicle to be started based at least in part on the presence of snow being detected.

14. The apparatus of claim 12, further comprising:
the controller being configured to cause the engine of the vehicle to be started a plurality of times over a time period based at least in part on the presence of snow being detected.

15. The apparatus of claim 12, further comprising:
a temperature sensor;
the controller being configured to detect when a temperature reading from the temperature sensor is below a predetermined threshold; and
the controller being configured to cause the engine of the vehicle to be started based at least in part on the presence of snow being detected when the temperature reading from the temperature sensor is below the predetermined threshold.

16. The apparatus of claim 12, further comprising:
the controller being configured to inhibit the starting of the engine based on a low fuel condition.

17. The apparatus of claim 12, further comprising:
the controller being configured to coupled to an automotive battery of the vehicle.

18. The apparatus of claim 12, further comprising:
a detector for use in detecting physical contact from snow; and
the controller configured to place the snow sensor into an active state from an inactive state based at least in part on the detector detecting physical contact from snow.

19. The apparatus of claim 12, wherein the controller is incorporated in or comprises an engine control unit or a car alarm system of the vehicle.

20. An apparatus for melting snow on an automobile, comprising:
a sensor for use in detecting a presence of snow over the automobile;
a controller; and
the controller configured to cause a heater and/or a defroster of the automobile to be started one or more times based at least in part on the presence of snow being detected.

21. The apparatus of claim 20, wherein the controller is coupled to a vehicular battery which is coupled to the engine.

22. The apparatus of claim 20, wherein the controller comprises an engine control unit (ECU) or a car alarm system of the automobile.

23. The apparatus of claim 20, wherein the controller configured to cause an engine of the automobile to be started one or more times based at least in part on the presence of snow being detected.
